(19) United States
(12) Patent Application Publication
(10) Pub. No.: US 2004/0001711 A1
(43) Pub. Date: Jan. 1, 2004

(54) Lightpath segment protection for WDM networks

(76) Inventors: Kirby Koster, Almonte (CA); Jesse Zhang, Ottawa (CA); Aravind Keshav Mistry, Ottawa (CA); Peter Howard Strong, Ottawa (CA); Jean Dolbec, Ottawa (CA); Doug MacLean, Ottawa (CA); Mark Steven Wolff, Ottawa (CA)

Correspondence Address: MARKS & CLERK, P.O. BOX 957, STATION B, OTTAWA, ON, K1P 5S7, CA

(21) Appl. No.: 10/606,239

(22) Filed: Jun. 26, 2003

Related U.S. Application Data
(60) Provisional application No. 60/391,404, filed on Jun. 26, 2002.

(51) Int. Cl. H04J 14/00

(52) U.S. Cl. 398/40

(57) ABSTRACT

This invention proposes a method for enabling segment protection, whereby one or more hops in the lightpath are protected by either a dedicated or shared wavelength. This provides a more cost effective solution for the service provider such that they only need to configure protection, and therefore deploy equipment, to those sensitive portions of the network rather than dedicating wavelengths and equipment for protection end-to-end for a lightpath. Further, allowing protecting wavelengths to be shared for protection, gives further flexibility and therefore, savings, to the service provider. To utilize lightpath segment protection and sharing the protection between multiple lightpaths requires the new mesh networking capabilities of the network elements and new network management tools to configure, and monitor these protected lightpaths.

### This application claims the benefit of U.S. Provisional Application No. 60/391,404 filed Jun. 26, 2002.

### FIELD OF THE INVENTION

This invention relates to optical networking and network management in a telecommunications environment and more particularly to the protection of lightpath segments in a wavelength division multiplex (WDM) network.

### BACKGROUND

Network operators are starting to deploy mesh WDM networks whereby lightpath segments or hops carrying one or more wavelengths are connected in order to provide an end to end lightpath through the network. Traditional protection schemes are limited to two options: 1) full, whereby an entire wavelength is dedicated for every hop in the lightpath and 2) none, whereby the path is not protected at all.

Carrier based WDM systems of today are typically in a ring architecture. To protect a wavelength in a ring architecture requires that an entire wavelength be dedicated for a protection path. This protection path, is usually the same frequency, in the opposite direction on the ring (see FIG. 1). The only other option is to provide no protection. The carrier is therefore left with this ‘all or nothing’ approach to wavelength protection. This approach does not work in the following situations:

1) Full protection can be too costly where protection is required for a portion of the lightpath. There are many situations where the carrier may wish to provide some protection for one or more lightpaths between specific physical locations. For example, significant construction is going to take place on a corridor or roadway that a fiber cable (providing one hop in a multi-hop lightpath) is buried under. The all or none approach would require that full end-to-end protection routes across multiple hops for each lightpath traversing the corridor would need to be configured. (See FIG. 2). This full protection would result in higher numbers of wavelengths, and equipment being used and configured to protect the lightpaths, since multiple hops would be protected instead of just the hop at risk.

2) For maintenance purposes, the carrier may wish to change the routing of the lightpath around the hop at risk for a short period of time without disrupting service to the path, for example, to replace a fiber. In systems supporting only full end-to-end protection, to protect that one hop would require that full alternate path be found and provisioned in order that the lightpath can be moved. This is a very inefficient use of network resources. If the alternate was used, i.e. no protection, the service would be disrupted until the change was completed.

This invention proposes a method for enabling segment protection, whereby one or more hops in the lightpath are protected by either a dedicated or shared wavelength. This provides a more cost effective solution for the service provider such that they only need to configure protection, and therefore deploy equipment, to those sensitive portions of the network rather than dedicating wavelengths and equipment for protection, end-to-end, for a lightpath. Further, allowing protecting wavelengths to be shared provides flexibility and therefore, savings, to the service provider. To utilize lightpath segment protection and sharing the protection between multiple lightpaths requires new mesh networking capabilities of the network elements and new network management tools to configure, and monitor these protected lightpaths.

Segment protection allows the carrier to protect only those portions of the lightpath that require protection. This makes more effective use of network resources and enables more flexibility for maintenance activities. Using the same example, the single part of the network requiring protection, can be protected (see FIG. 3).

Current networking solutions (both equipment and management) do not enable the operator to configure this type of protection.

### SUMMARY OF THE INVENTION

It is an object of the present invention to provide a method for enabling lightpath segment protection, whereby one or more hops in the lightpath are protected by either a dedicated or shared wavelength.

Therefore, in accordance with a first aspect of the present invention there is provided a method of protecting lightpath segments in a wavelength division multiplex network wherein one or more working segments of the complete lightpath are protected by one or more protection paths.

In preferred embodiments of the invention the protection path employs either a dedicated wavelength or a shared wavelength.

### BRIEF DESCRIPTION OF THE DRAWINGS

The invention will now be described in greater detail with reference to the attached drawings wherein:

FIG. 1 shows wavelength protection in a ring network;

FIG. 2 illustrates full end to end protection in a mesh network;

FIG. 3 illustrates segment protection in a mesh network;

FIG. 4 illustrates the connections in a one plus one segment protection in a lightpath;

FIG. 5 shows an N+M segment protection;

FIG. 6 shows a highlighted working path and protection path on a GUI; and

FIG. 7 is a network management in view of lightpath with segment detection.

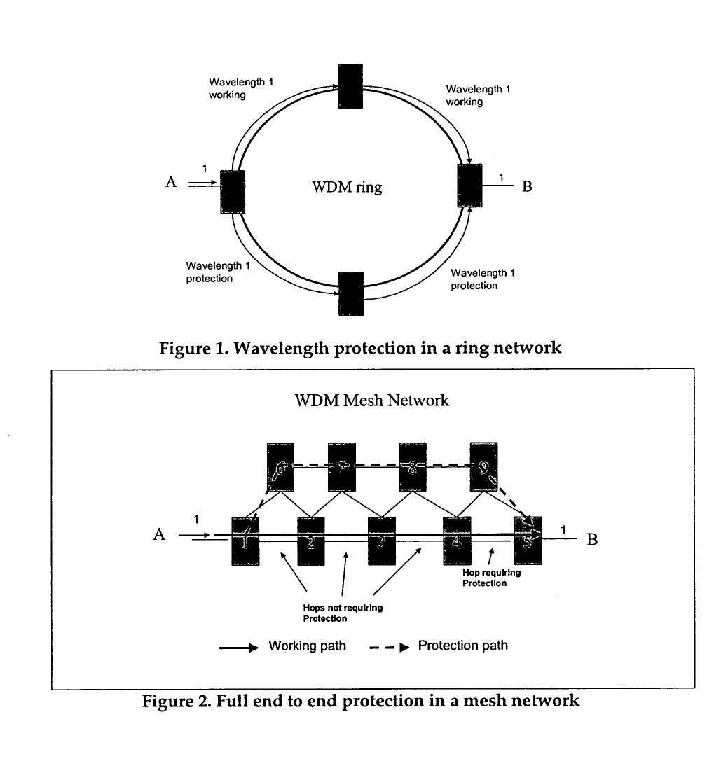

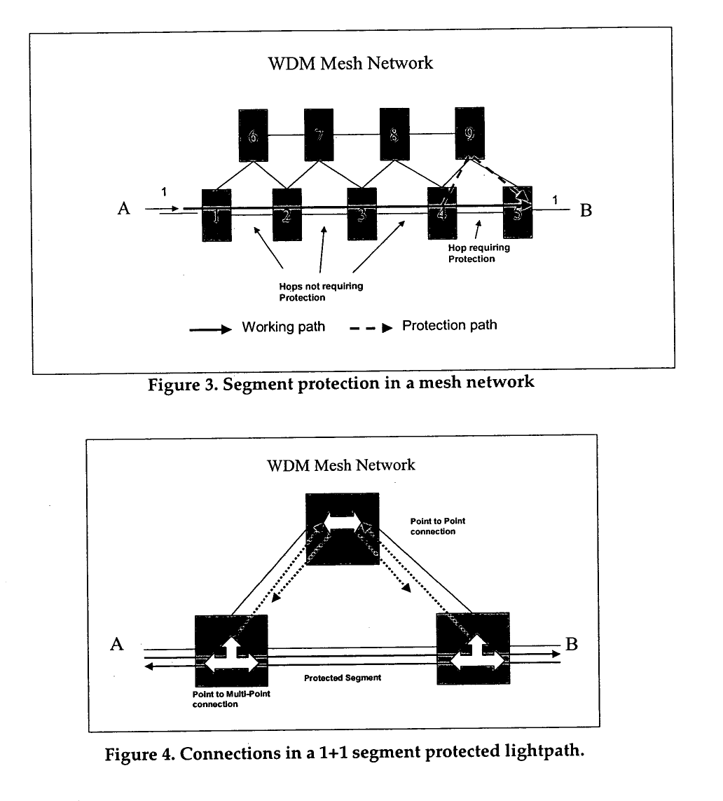

### DETAILED DESCRIPTION OF THE INVENTION

The invention creates the capability of configuring and monitoring lightpaths with segment protection. Further, two distinct options are provided, first a single protection branch is dedicated for protection of a single working wavelength—called 1+1 protection and, second an option wherein sharing is achieved whereby N branches are used to protect M path segments called N+M protection.

There are two entities contributing to this invention, the network elements and the network management system.

For the 1+1 case, the network elements use a dedicated wavelength in a protection path. In order to do this, the network elements create a point to multipoint connection at each end of the lightpath. These connections allow the data to be transmitted on two paths. At the same time, the system receives data from the working path. In normal operation, identical data is sent over both paths. In the event of a protection switch-over, either controlled or due to a failure in the network, the network elements with the point to multi-point connections change their transceivers to the protection path. This provides a highly robust and extremely fast protection switch.

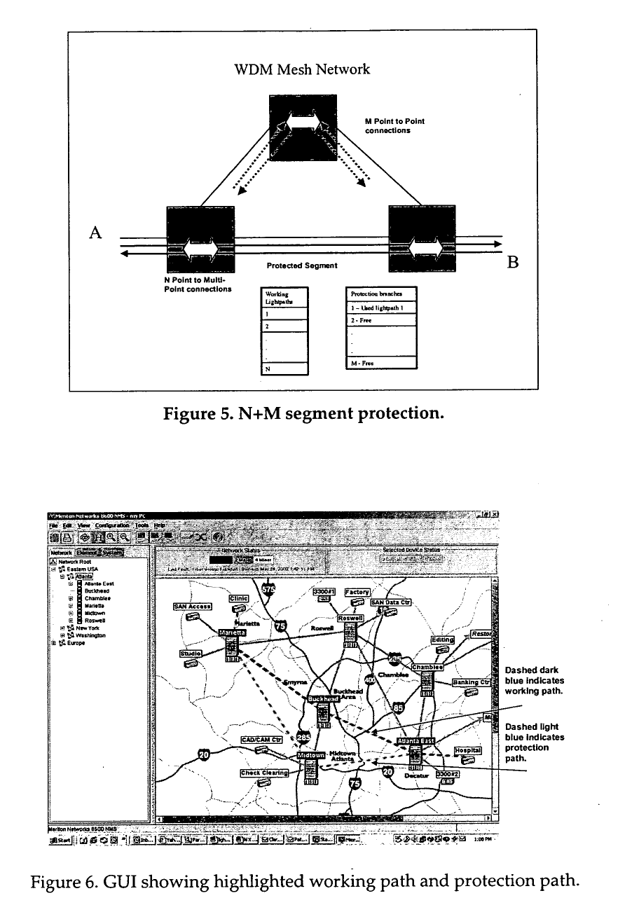

The N+M protection scheme is handled in software rather than hardware. In this case, the network elements do not create point to multi-point connections, just point to point connections for the working path. Software then, creates and manages two tables, 1) the list of lightpaths that are being protected and 2) the list of protection branches. See FIG. 5.

Software at the two endpoints coordinate, in the event of a protection switch, to move the connections from the working path to the protection path. In the case of the controlled switch (ie. operator initiated and no failure present in the system), a similar strategy is used as in the 1+1 protection case: e.g.

Step 1: Nodes A and B coordinate and agree on which protection branch is to be used. (eg 1).

Step 2: Nodes A and B create point to multi-point connections from the working path to the protection branch. Note that this is done by simply adding a leaf to the existing connection. There is no impact to service.

Step 3: Nodes A and B ensure that both point to multi-point connections are created and in-service.

Step 4: Nodes A and B coordinate to roll the lightpath to the protection branch by changing the transceivers to the protection branch.

This strategy ensures that there is no disruption to service during the switch over. In the failure case, there is already impact to service and the intention is to move traffic to the protection path as quickly as possible. As a result, there are fewer steps: e.g.

Step 1: Nodes A and B agree on which protection branch to use (eg. 1)

Step 2: Nodes A and B independently create new point to point connections to the protection branch.

Step 3: Nodes A and B coordinate to determine the new status of the lightpath.

Due to the uniqueness of this segment protection capability, existing network management applications do not support this capability. As a result, this invention also covers the creation of the protection branches as well as the monitoring and switching of the lightpaths by the network management system. The two distinct cases (i.e., 1+1 and N+M) need to be considered.

In a 1+1 segment protection scheme, the operator wishes to create a dedicated protection branch. The following steps are followed:

1. Select lightpath to be protected from the ‘Lightpath Manager’.

2. Select ‘Add maintenance branch’ from the pull down menu.

3. Use the network management tools to configure the route of the protection branch.

4. Save the protection branch. This saves the configuration to the network management system's database.

5. Connect the protection branch. At this point, the network management system creates the point to multi-point connections on the edge network elements as well as any point to point connections on the tandem network elements. This is accomplished using a network management protocol such as SNMP or TL1.

The network management also functions to enable a controlled switch over to the protection branch. This is accomplished by the following steps:

1. Select lightpath to switch from the ‘Lightpath Manager.’

2. Select ‘Roll’ from the pull down menu.

3. The network management system then issues ‘switch’ commands to both endpoint network elements. The network elements then switch to receive data from the protection branch.

4. The network management system confirms the completion of the transaction.

To monitor a lightpath with segment protection, the network manager utilizes the lightpath highlighting feature to show the route of the working path (dark blue) and protection branch (light blue) on the network management map. (see FIG. 6)

Provisional application serial No. 60/391,406 filed Jun. 26, 2002, provides greater detail on the lightpath highlighting feature. The contents of that application are incorporated herein by reference.

Lightpath status includes the status of the protection branch. If there is a problem on the protection branch such that the lightpath could not switch over, the lightpath is considered degraded.

The network management function must also enable the user to create the protection segment group (a group of paths with a common segment to protect) and the segment branch group (a group of branches that will protect the selected segment). The network management system follows the following steps to do this:

1. Start the lambda selection tool.

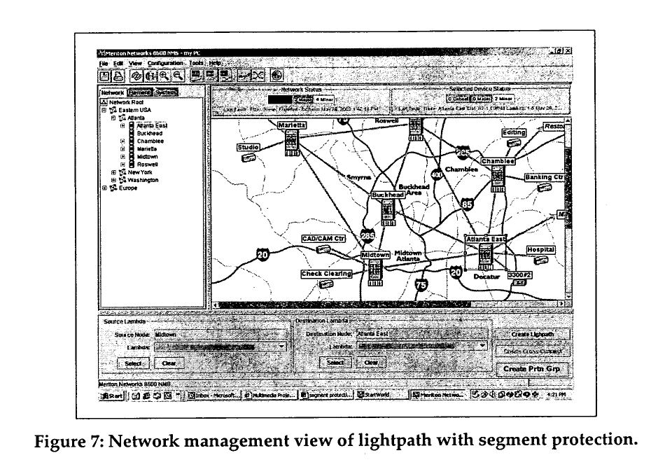

2. Select the source and destination of the segment to be protected by selecting the node on the map and then selecting ‘select’ in the lambda selection tool. (see FIG. 7)

3. The network management system then enables the user to select the route between the source and destination node to be protected.

4. The user then selects the wavelengths to be protected.

5. Steps 3 and 4 are then repeated but for the protection segments.

6. The network management system then creates the protection segments on the appropriate network elements.

7. The network management system then creates the protection group on the endpoint network elements. On receipt of this request, the network elements are able to create the data structures needed to manage the protection groups.

Once N+M segment protection has been created, all lightpaths configured through the working fiber or segment, will automatically be protected by the segment protection group. Likewise, the network management system will ensure that no new lightpaths are configured to have working paths using the wavelengths that are part of the segment protection group.

The network management function also provides the ability to monitor protection groups. Using the highlight feature on a protection group will display the group in light blue and the working segment in dark blue for example.

The 1+1 case is handled is the following manner:

1. The two end-point network elements coordinate to ensure both are receiving data on the same wavelength.

2. In the even of failure, or triggered by the network management system, the two endpoint network elements coordinate via signaling, to switch to the protection branch.

The N+M case is handled as follows:

1. The two endpoints create the data structures to contain the lists of 1) protected lightpaths and 2) the protection branches.

2. In the event of failure, or triggered by the network management system, the two endpoints coordinate via signaling to choose a protection segment to switch to. They then coordinate the protection switch via a coordinated algorithm.

The network management methodology is described above.

Although certain embodiments of the invention have been and illustrated it will be apparent to one skilled in the art that numerous changes can be made to the basic concept. It is to be understood, however, that such changes will fall within the full scope of the invention as defined by the appended claims.

We claim:

1. A method of protecting a lightpath segment in a mesh, wavelength division multiplexed (WDM) communications network wherein said mesh WDM network has multiple lightpath segments, the method comprising: providing a protection path for a selected one of said lightpath segments.

2. The method as defined in claim 1 wherein said protection path employs a dedicated wavelength.

3. The method as defined in claim 1 wherein each lightpath segment has a network element at each end thereof, said respective network elements coordinating a switch over from a working path to said protection path.

4. The method as defined in claim 3 wherein said switch over is completed in response to instruction received from a network management system (NMS).

5. The method as defined in claim 3 wherein said switch over is completed in response to a failure in said working path.

6. The method as defined in claim 4 wherein said network management system controls functionality of said communications network.

7. The method as defined in claim 6 wherein said NMS functions to establish said protection path.

8. The method as defined in claim 6 wherein said NMS monitors status of said protection path.

9. The method as defined in claim 6 wherein said NMS provides an operator with a graphical interface to monitor routing of said protection path.

10. A method of protecting multiple lightpath segments in a mesh, wavelength division multiplexed (WDM) communications network wherein said mesh WDM network has multiple lightpath segments, the method comprising providing multiple protection paths for one or more of said multiple light path segments.

11. The method as defined in claim 10 wherein said multiple protection paths employ a shared wavelength.

12. The method as defined in claim 10 wherein each lightpath segment has a network element at each end thereof, said respective network elements coordinating a switch over from a working path to one of said multiple protection paths.

13. The method as defined in claim 12 wherein said switch over is completed in response to instruction received from a network management system (NMS).

14. The method as defined in claim 12 wherein said switch over is completed in response to a failure in said working path.

15. The method as defined in claim 13 wherein said network management system controls functionality of said communications network.

16. The method as defined in claim 15 wherein said NMS functions to establish said one or more protection paths.

17. The method as defined in claim 15 wherein said NMS monitors status of each of said one or more protection paths.

18. The method as defined in claim 15 wherein said NMS provides an operator with a graphical interface to monitor routing of said one or more protection paths.
